(19) United States
(12) Patent Application Publication
(10) Pub. No.: US 2012/0019134 A1
(43) Pub. Date: Jan. 26, 2012

(54) HIGH GAIN COATINGS AND METHODS

(76) Inventors: Miles Rains, Burbank, CA (US); Howard R. Gray, Sebastopol, CA (US); Leroy A. Bartolomei, Santa Rosa, CA (US); Norman L. Boling, Santa Rosa, CA (US)

(21) Appl. No.: 13/187,228

(22) Filed: Jul. 20, 2011

Related U.S. Application Data
(60) Provisional application No. 61/366,110, filed on Jul. 20, 2010.

(51) Int. Cl. H01K 1/32; H01J 9/20

(52) U.S. Cl. 313/578; 445/58

(57) ABSTRACT

A halogen incandescent burner comprising a quartz body comprising a light emitting chamber, a filament positioned within the light emitting chamber, and a multilayer optical coating on at least a portion of the chamber. The coating may include a plurality of layers of a low refractive index material and a high refractive index material having a total thickness of at least nine microns, wherein the gain of the burner is at least 1.7. The high refractive index material may comprise tantala and the low refractive index material may comprise silica.

### RELATED APPLICATIONS

The instant application is a non-provisional application of and is co-pending with and claims the priority benefit of U.S. Provisional Patent Application No. 61/366,110 filed Jul. 20, 2010, entitled “High Gain Coating and Method,” the entirety of which is incorporated herein by reference.

### BACKGROUND

Embodiments of the present subject matter generally relate to multi-layer reflector coatings for various applications, such as, but not limited to, halogen incandescent (HIR) lamps, and the like.

It is known in the art to provide thin film optical coatings comprising alternating layers of two or more materials of different indices of refraction to coat reflectors and lamp envelopes. Such coatings or films may be employed to selectively reflect or transmit light radiation or energy from various portions of the electromagnetic radiation spectrum such as ultraviolet, visible and infrared (IR) radiation. The terms radiation and energy may be used interchangeably herein and such use should not limit the scope of the claims appended herewith.

One issue with incandescent lamps and HIR lamps, however, is their relatively low luminous efficacy, with approximately ten to fifteen percent of the light emitted by the tungsten filament being emitted in the visible light spectrum. Remaining energy may be emitted in the IR energy spectrum, dissipated as heat, dissipated through gas losses, end losses, and lead losses. In the industry, an IR reflective coating is commonly deposited on incandescent lamps to reflect IR energy emitted by a filament or arc back to the filament while transmitting the visible light portion of the electromagnetic spectrum emitted by the filament. This decreases the amount of electrical energy supplied to maintain operating temperature of the filament and improves the lamp's respective efficacy. Thus, the more IR energy reflected back to the filament, the more Lumens per Watt (LpW) obtainable by the lamp. Generally, IR coatings are typically formed from stacks of dielectric materials. These materials may include alternating high-index and low-index layers and may be deposited using a variety of techniques such as, but not limited to, reactive sputtering, physical vapor deposition (PVD), low pressure chemical vapor deposition (LPCVD), plasma-enhanced chemical vapor deposition (PECVD), and electron-beam deposition. Such coatings may be deposited upon all types of incandescent lamps including, but not limited to, single and double ended quartz halogen burners. Such coatings may be employed to reflect the shorter wavelength portions of the electromagnetic spectrum, such as the ultraviolet and/or visible light portions emitted by the filament or arc and may also be employed to transmit primarily other portions of the spectrum to provide heat radiation with little or no visible light radiation.

A common method of assessing lamps is by determining a lamp's output in Lumens (L). Lumens may be measured by determining the power radiated by a lamp and weighting the power according to the spectral sensitivity of the eye. For example, a typical 60 W A-line incandescent lamp with no coating, no halogen burner and a tungsten filament emits approximately 900 L providing an efficacy of 15 Lumens per Watt (LpW). A comparable 100 W A-line lamp emits about 1600 L, or 16 LpW. A lamp with a conventional IR coating and a halogen burner, however, may emit the same number of Lumens using less power thereby providing a higher efficiency. Such lamps find particular use in applications such as, but not limited to, torchiere lamps and other fixtures requiring a high lumen output.

A model has been developed by Rolf Bergman of General Electric to predict the effectiveness of various coatings and lamp designs with regard to energy returned to a lamp filament. To understand the Bergman model, several features of IR reflective films may be considered. The terms reflective, reflected and/or reflecting may be used interchangeably herein and such use should not limit the scope of the claims appended herewith. For example, a Hybrid Incandescent Lamp generally employs a filter on the outside of a halogen lamp to reflect emitted IR energy back to the filament or arc. The reflected IR energy may be absorbed by the filament which reduces the amount of electrical energy necessary to maintain filament operating temperature thereby increasing lamp efficacy. An increase in efficacy obtainable by this method may be limited by certain considerations including there is likely no filter that reflects 100 percent of IR energy, the optical coupling of the filter on the lamp envelope and the filament is likely imperfect, and the filament does not likely absorb all of the IR energy reflected back to the filament.

With these considerations in mind, the Bergman model examines a cylindrical IR reflector having a reflectivity of R(1) located concentrically around a cylindrical filament. A multi-pass ray tracing model may be employed to determine the amount of emitted radiation reabsorbed by the filament thereby providing the following relationship:

$${F}_{ ab s} ( λ ) = {\int }_{λ} \frac{{a}_{λ} ( λ ) GR ( λ )}{1 - ( 1 - {a}_{λ} ( λ ) ) GR ( λ )} d λ \qquad ( 1 )$$

where G is a geometry factor that represents the optical coupling between reflected IR energy and the filament, R represents the reflectance of the IR film or coating, and a(λ) represents the absorptivity of the filament as a function of wavelength. The Bergman model may then be expanded to account for the effects of filament centering. For example, when the filament of a lamp is radially offset, some reflected radiation may miss the filament thereby requiring multiple bounces before reabsorption. Thus, radial offset, whether due to filament misplacement or filament sag, may decrease the amount of IR energy absorbed by the filament thereby leading to a decrease in efficacy. Accounting for filament offset, Equation (1) may be rewritten as:

$${F}_{a bs} ( λ ) = {\int }_{λ} \frac{{a}_{λ} ( λ ) GR ( λ ) S}{1 - ( 1 - {a}_{λ} ( λ ) ) GR ( λ ) S} d λ \qquad ( 2 )$$

where S represents the filament offset. Scattering in the film may effectively increase this factor by causing the reflected light to miss the filament thereby having the same practical effect as the filament being off center. Scattering or scatter effects may therefore be taken into account by adjusting the S factor accordingly.

There are many apparatuses and methods in the industry which attempt to increase the efficacy of a lamp by mechanical means or through use of various materials. For example, U.S. Pat. Nos. 6,281,620, 5,675,218, 4,728,848, and 6,659,829 and U.S. Published Patent Application No. 20060163990 provide various methods to align a lamp filament to increase the reabsorption of reflected IR energy or provide methods to shape the lamp so reflected IR energy is more focused. Additional IR filter designs are provided in U.S. Pat. Nos. 4,017,758, 4,160,929, 4,229,066, and 6,239,550. Materials such as niobia (Nb₂O₅), titania (TiO₂), and zirconia (ZrO₂) are commonly used high index materials in IR reflecting interference filters. U.S. Pat. No. 4,701,663 uses such materials. Tantala (Ta₂O₅) is also a known high-index material. U.S. Pat. Nos. 4,588,923, 4,689,519, 6,239,550, 6,336,837 and 6,992,446 provide lamps having IR filters made from tantala and silica.

It has, however, proven difficult to manufacture an optimal IR reflecting interference film in practice. For example, to make an IR film more reflective than the current state of the art IR filters, the film must be thicker; however, as a film's thickness increases, especially at the higher operating temperatures of a halogen lamp envelope (e.g., 800° C.), the film may fail due to mechanical stresses and/or crack or peel off the respective substrate. U.S. Pat. No. 4,701,663 discloses a deposited filter made of titania and silica and admits that severe film stress occurs at a temperature of about 600° C. causing the film to peel off the substrate. U.S. Pat. No. 4,734,614 also recognizes that severe stress occurs in tantala and silica filters at higher temperatures and suggests niobia as a replacement to improve film stress but does not solve the mechanical stress problem. U.S. Pat. Nos. 4,524,410 and 5,425,532 also address mechanical film stress issues in multilayer IR films. Yet another disadvantage with thicker films is that the stress may be sufficient to break the respective halogen lamp envelope. As a result, conventional IR filters made using these materials have limited thickness, meaning the IR reflectance is less than optimal. The thickness for such conventional films is generally between about 1.5 microns and about 4 microns. U.S. Pat. Nos. 4,558,923, 4,949,005 and 6,336,837 provide such conventional films.

Another problem with these conventional films is scattering. For example, the more scattering induced by a film, the less effective the film is at reflecting IR energy back to the filament or arc, as much of the reflected light misses the filament entirely. Eventually, the amount of IR energy lost through scattering may be equal to or greater than the amount of additional IR reflected back to the filament due to greater film thickness. Films deposited at high temperature, such as those made with CVD processes, tend to have a lower scattering effect but have higher stress. Films made by sputtering generally provide films with lower stress but with a higher scattering effect. Thus, there is a need in the art to manufacture a thicker IR reflector that does not suffer from either unacceptably high stresses or unacceptably high scattering. There is also a need in the art for a thin film interference filter having a thickness adaptable to reflect high levels of IR energy back to a lamp filament and still provide low levels of both stress and scattering.

### SUMMARY

Embodiments of the present subject matter generally concern thin film optical interference filters having alternating layers of tantala and silica. Exemplary applications of these filters may be coatings that reflect IR energy back to an incandescent light bulb filament or arc. Exemplary coatings may reflect more IR energy and provide a higher gain in lamp efficiency than conventional coatings. In practice, conventional coatings or films do not provide an increase in gain exhibited in embodiments of the present subject matter for at least two reasons: the thicker the conventional film the greater the scattering (even though reflectance may increase) and thus a resultant reduction in gain, and the thicker the conventional film the higher the stress thereby increasing mechanical defects in the respective device or apparatus.

Exemplary embodiments of the present subject matter may employ a sputtering process to make tantala and silica films or coatings having both low stress and low scattering such that the films or coatings may be double the thickness of conventional state of the art coatings. Filters utilizing such coatings according to embodiments of the present subject matter are suitable for high temperatures applications such as standard lighting materials, quartz halogen burners, and the like. Embodiments of the present subject matter are also not subject to cracking, peeling, or high scattering effects. During experimentation, an exemplary sputtering process having an ability to produce lower stress films was expected to allow production of slightly thicker than normal IR reflection filters, but film scatter was predicted to be a limiting factor that would prevent any large gains in thickness. This was true for films having alternating layers of zirconia and silica or titania and silica whereby film scattering made either design unusable after achieving a thickness of approximately six microns. An interference film having alternating layers of tantala and silica, however, provided an unexpectedly low scattering effect at thicknesses greater than four microns. The scattering and stress exhibited by films employing tantala and silica films according to embodiments of the present subject matter were so low that film thicknesses of up to 15 microns were achieved. Thus, these exemplary thick films, despite what knowledge common to those of skill in the art would predict, did not crack, peel, or break the halogen lamp envelope. Further, optical characteristics exhibited by films according to embodiments of the present subject matter were unexpectedly high and further, unexpectedly high amounts of IR energy were reflected. As a result, halogen lamps employing films according to embodiments of the present subject matter exhibited an unexpectedly high increase in gain, which measures the amount of IR radiation returned to the filament. This may be accomplished by measuring the power needed to bring a filament to a given resistance when the respective lamp is uncoated, repeating the measurement when the lamp is coated, and taking the ratio of the two measurements. More specifically, gain (P₂/P₁) may be represented as the ratio of the measured power when the lamp is coated (P₂) to the measured power of an uncoated burner needed to bring the filament to a given resistance (P₁). Lamps having such exemplary films also exhibited a higher than predicted increase in efficacy measured in Lumens per Watt for the respective film design.

Therefore, one embodiment of the present subject matter provides a halogen incandescent burner comprising a quartz body comprising a light emitting chamber, a filament positioned within the light emitting chamber, and a multilayer optical coating on at least a portion of the chamber. The coating may comprise a plurality of layers of a low refractive index material and a high refractive index material having a total thickness of at least nine microns where the gain of the burner is at least 1.7.

Another embodiment of the present subject matter provides a halogen incandescent burner having an IR reflecting coating on at least a portion thereof, the coating comprising alternating layers of tantala and silica and having a total thickness of greater than nine microns and a gain of at least 1.7.

A further embodiment of the present subject matter may provide a halogen incandescent burner having an IR reflecting coating on at least a portion thereof, the coating comprising alternating layers of tantala and silica and having a total thickness of greater than nine microns and an average reflectance over the range of wavelengths from 800 nm to 1500 nm of at least 97.

An additional embodiment of the present subject matter provides a halogen incandescent burner having an IR reflecting coating on at least a portion thereof, the coating comprising alternating layers of tantala and silica and having a total thickness of greater than nine microns and a luminous efficiency of at least thirty lumens per watt over at least five hundred hours of operation.

One embodiment of the present subject matter provides a method of improving the lumens per watt of a halogen incandescent burner. The method may include sputter coating at least a portion of the burner with a multilayer IR reflecting coating having alternating layers of tantala and silica a total thickness of at least nine microns.

An additional embodiment of the present subject matter provides a method comprising providing a lamp burner having a quartz body forming a light emitting chamber housing an incandescent filament and sputter coating at least a portion of the light emitting chamber to form a multilayer IR reflecting coating having a plurality of layers of tantala and silica and a total thickness of at least nine microns. The gain realized by coating the burner may be at least 1.7.

These embodiments and many other objects and advantages thereof will be readily apparent to one skilled in the art to which the invention pertains from a perusal of the claims, the appended drawings, and the following detailed description of the embodiments.

### BRIEF DESCRIPTION OF THE DRAWINGS

FIG. 1 is a graphical representation of spectral performance versus wavelength for an embodiment of the present subject matter over the spectral range of 250 nm to 3500 nm.

FIG. 2 is a graphical representation of spectral performance versus wavelength for an embodiment of the present subject matter over the spectral range of 750 nm to 3000 nm.

FIG. 3 is a pictorial representation comparing a bare bulb, a four micron three material coating, a six micron three material coating, and an embodiment of the present subject matter.

FIG. 4 is a plan view of one embodiment of the present subject matter.

FIG. 5 is a perspective view of an exemplary magnetron sputtering system.

FIG. 6 is a perspective view of a sputtering system having tooling allowing more than one degree of rotational freedom.

### DETAILED DESCRIPTION OF THE DRAWINGS

With reference to the figures where like elements have been given like numerical designations to facilitate an understanding of the present subject matter, the various embodiments of high gain coatings and methods are herein described.

Embodiments of the present subject matter generally relate to the deposition of materials on substrates to make thin film coatings and provide utility in making lamps wherein a coating is formed on at least part of the surface of a lamp burner. While the present subject matter relates generally to the manufacture of lamps, the description hereinafter will be described with reference to a halogen lamp, but the claims appended herewith should not be so limited.

Conventional halogen lamps are generally manufactured with a coating deposited on at least a part of the respective lamp burner. Such lamps are typically made by the sequential steps of (i) forming the lamp burner envelope from a generally tubular section of light transmitting material, (ii) positioning electrical leads and/or electrodes relative to the lamp burner envelope, (iii) hermetically sealing the burner envelope to the electrical leads to seal the light emitting chamber of the lamp, and (iv) forming a coating on at least part of the surface of the lamp burner. Exemplary light transmitting material may include materials such as, but not limited to, glass, quartz glass, ceramic materials and the like.

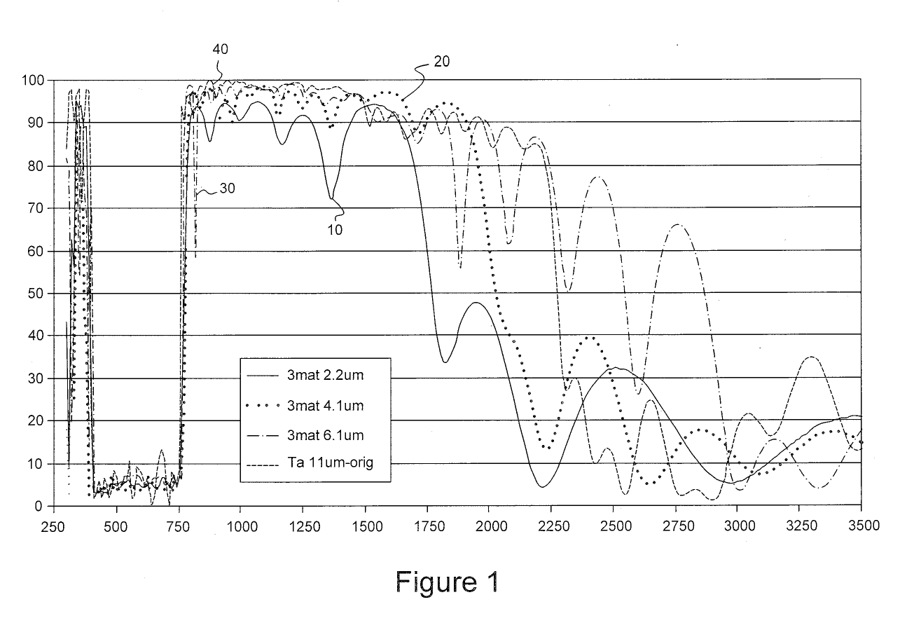

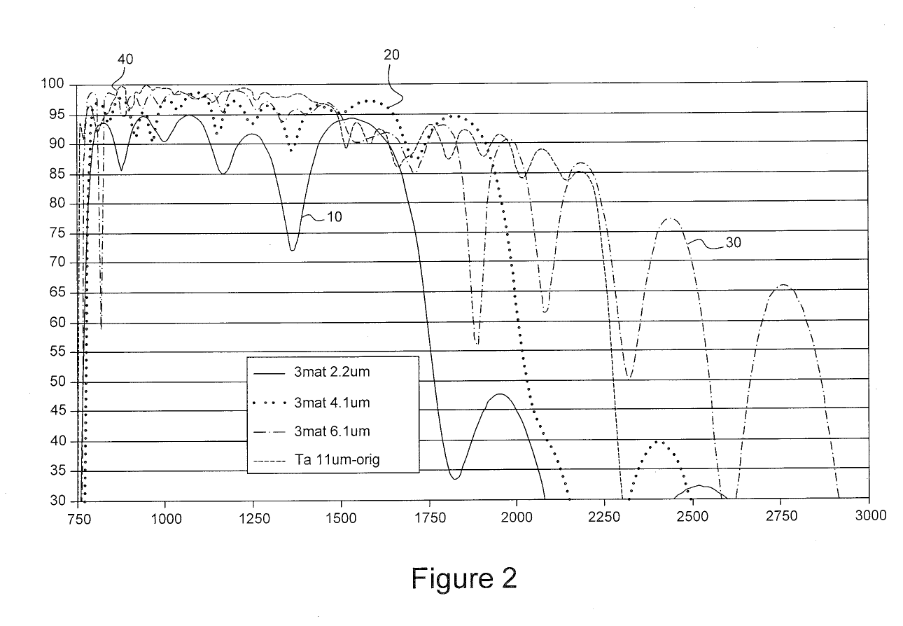

FIG. 1 is a graphical representation of spectral performance versus wavelength for an embodiment of the present subject matter over the spectral range of 250 nm to 3500 nm. FIG. 2 is a graphical representation of spectral performance versus wavelength for an embodiment of the present subject matter over the spectral range of 750 nm to 3000 nm. With reference to FIGS. 1-2, a three material 2.2 micron coating 10 exhibited an average reflectance (R) of 89.3 in the 800-1500 nm range. This is comparable to a 4 micron, 47 layer Nb₂O₅/SiO₂ IRR design. A 67 layer three material 4.1 micron design 20 exhibited an average R of 95.4. This is generally referred to as a convention or “standard” design thickness. A three material 6.1 micron coating 30 exhibited an average R of 95.6 and generally demonstrates problems encountered in the industry with thicker IR reflecting designs. That is, the coating 30 is fifty percent thicker than the standard four micron design, yet shows virtually no increase in the amount of IR energy reflected back to the filament. As previously discussed, this is due to increasing losses from scattering and a general degradation in the optical and mechanical performance of the film. In contrast to the three previous coatings 10, 20, 30, a two material 11 micron film 40 according to an embodiment of the present subject matter, exhibited a marked increase in performance with an average R of 97.9 in the 800-1500 nm range despite being more than twice as thick as the standard film.

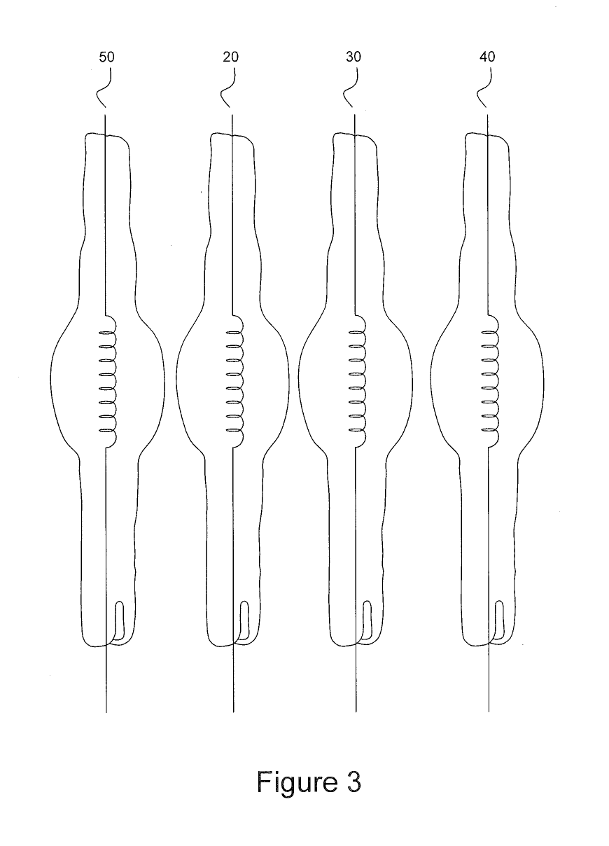

FIG. 3 is a pictorial representation comparing a bare bulb, a four micron three material coating, a six micron three material coating, and an embodiment of the present subject matter. With reference to FIG. 3, the effect of scatter on actual gain of a lamp is demonstrated through the comparison of a bare bulb 50 with a bulb having the three material four micron coating 20, a bulb having the three material six micron coating 30, and an embodiment of the present subject matter having a two material eleven micron coating or film 40. As shown, the four micron coating 20 results in a film with some scattering, but little enough that the gain of the lamp may be improved. The six micron coating 30 provides a marked increase in scattering and demonstrates why a 50% increase in coating thickness does not provide an increase in the efficacy of the lamp, as any possible gain in efficiency due to the increased reflectance is offset by the higher scatter thereby causing much of the reflected light to miss the filament entirely. In contrast, the eleven micron coating 40 provides a higher reflectance due to its increased thickness and has film scattering comparable to the four micron coating 20 thereby resulting in a large gain in lamp efficiency. The eleven micron coating 40 may provide slightly more scattering than the four micron coating 20, but the attendant increase in reflectance for the eleven micron coating 40 more than offsets the loss from the small increase in scatter. Thus, a 60 W lamp with an eleven micron coating according to an embodiment of the present subject matter may emit, for example, 2560 L and have an efficacy of approximately 43 LpW. In comparison, conventional Philips Halogena 40 W=60 W and 70 W=100 W bulbs provide efficiencies of 20 LpW and 23 LpW, respectively. Table 1 below provides a listing of gains for exemplary embodiments of the present subject matter.

TABLE 1

| Lamp | Volts | Amps | Lumens | Watts | LpW | l/l0 | p0/0 | gain |
|---|---|---|---|---|---|---|---|---|
| Const-V | 100 | 0.4972 | 456.435 | 49.7 | 9.2 | | | |
| precoat | 110 | 0.5241 | 644.683 | 57.7 | 11.2 | | | |
| | 120 | 0.5498 | 873.299 | 66.0 | 13.2 | | | |
| | 130 | 0.5746 | 1146.51 | 74.7 | 15.3 | | | |
| | 140 | 0.5987 | 1467.06 | 83.8 | 17.5 | | | |
| Const-HR | 75.93 | 0.3775 | 467.882 | 28.7 | 16.3 | 1.03 | 1.73 | 1.78 |
| postcoat | 83.003 | 0.3955 | 657.221 | 32.8 | 20.0 | 1.02 | 1.76 | 1.79 |
| | 90.28 | 0.4136 | 892.855 | 37.3 | 23.9 | 1.02 | 1.77 | 1.81 |
| | 97.431 | 0.4308 | 1168.45 | 42.0 | 27.8 | 1.02 | 1.78 | 1.81 |
| | 104.82 | 0.4482 | 1493.78 | 47.0 | 31.8 | 1.02 | 1.78 | 1.82 |
| Const-V | 120 | 0.4826 | 2324.76 | 57.9 | 40.1 | | | |
| postcoat | | | | | | | | |

It should be noted that the values and embodiments provided above in Table 1 are exemplary only and should not limit the scope of the claims appended herewith as multilayer IR reflecting coatings according to embodiments of the present subject matter may exhibit values, e.g., gain, lumens, LpW, etc., commensurate with various exemplary coatings having any number of layers of tantala, silica, or other materials and having different thicknesses.

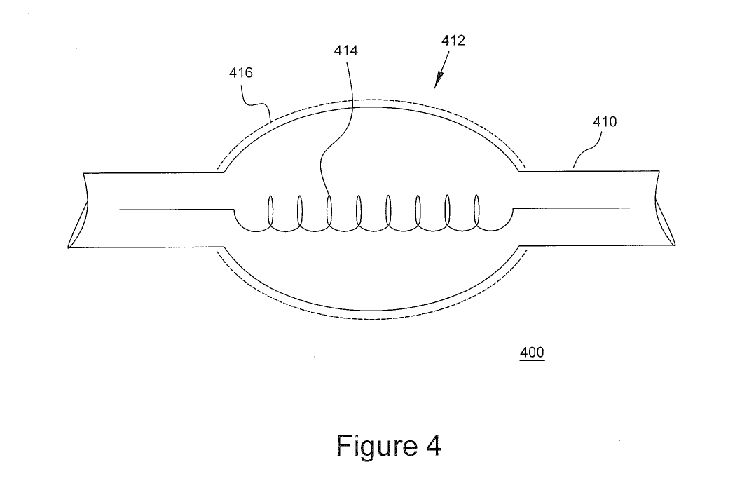

FIG. 4 is a plan view of one embodiment of the present subject matter. With reference to FIG. 4, one embodiment of the present subject matter may include halogen incandescent burner 400 having a quartz body 410 comprising a light emitting chamber 412 and a filament 414 positioned within the light emitting chamber 412. The burner 400 may be a double-ended burner as depicted or may be a single-ended burner. These burners may be any common wattage such as, but not limited to, 50 W, 60 W, etc.

A multilayer optical coating 416 may be deposited or sputtered on at least a portion of the chamber 412 where the coating 416 includes a plurality of layers of a low refractive index material and a high refractive index material having a total thickness of at least nine microns. The gain of the burner 400 may be at least 1.7. In one embodiment, the high refractive index material may be tantala. In another embodiment, the low refractive index material may be silica. Of course, the coating 416 may include alternating layers of tantala and silica. Employing an exemplary coating 416, the burner 400 may operate with a luminous efficiency of at least forty lumens per watt over at least one thousand hours of operation. The burner 400 may also be rated at, by way of a non-limiting example, sixty watts and operate with a luminous efficiency of about forty-three LpW over at least one thousand hours of operation. In another embodiment, the burner 400 may operate with a luminous efficiency of less than forty-three LpW, e.g., 20 LpW, 30 LpW over less than one thousand hours of operation, e.g., five hundred hours of operation, seven hundred hours of operation, etc. Of course, an exemplary burner 400 according to embodiments of the present subject matter may have an average reflectance over the range of wavelengths from 800 nm to 1500 nm of at least 97. Such a burner 400 may be employed as a light source in several types of lamps including, but not limited to, an A-line lamp, a general service lamp, a modified spectrum lamp, a reflector lamp, a parabolic reflector lamp, an ER/BR lamp, and a torchiere. A coating 416 according to an additional embodiment of the present subject matter may include alternating layers of tantala and silica having a total thickness of at least eleven microns where the gain of the burner 400 is at least 1.85. Yet another embodiment of the present subject matter may include an eleven micron tantala-silica IR reflecting coating having three reflection stacks and/or over 100 layers deposited on an exemplary double or single ended burner of any wattage. It should be noted that each of the aforementioned embodiments identifying specific efficiencies, gains, reflectance values, etc. are exemplary only and should in no way limit the scope of the claims appended herewith.

Of course, it is obvious to one skilled in the art that the scope of the claims appended herewith may encompass a multitude of variations in reflection or reflector design and may include coatings that are thinner or thicker than eleven or nine microns, may possess varying gains, and/or may possess varying average reflectance and luminous efficiency. For example, another embodiment of the present subject matter may include a halogen incandescent burner having an IR reflecting coating on at least a portion thereof. This coating may include alternating layers of tantala and silica and have a total thickness of greater than nine microns and an average reflectance over the range of wavelengths from 800 nm to 1500 nm of at least 97. In another embodiment, the coating may include alternating layers of tantala and silica and have a total thickness of greater than nine microns and a gain of at least 1.7. Of course, these coatings may also have a total thickness of at least eleven microns. An additional embodiment of the present subject matter may also provide a halogen incandescent burner having an IR reflecting coating on at least a portion thereof. This coating may include alternating layers of tantala and silica and have a total thickness of greater than nine microns and a luminous efficiency of at least forty lumens per watt over at least one thousand hours of operation. Of course, this coating may also have a total thickness of at least eleven microns.

Table 2 below provides another exemplary, but non-limiting, coating according to one embodiment of the present subject matter.

TABLE 2

| Layer Number | Material | Thickness (nm) |
|---|---|---|
| 1 | Ta₂O₅ | 109.8 |
| 2 | SiO₂ | 169.42 |
| 3 | Ta₂O₅ | 104.5 |
| 4 | SiO₂ | 149.84 |
| 5 | Ta₂O₅ | 99.55 |
| 6 | SiO₂ | 152.62 |
| 7 | Ta₂O₅ | 99.93 |
| 8 | SiO₂ | 152.48 |
| 9 | Ta₂O₅ | 95.65 |
| 10 | SiO₂ | 156.46 |
| 11 | Ta₂O₅ | 104.63 |
| 12 | SiO₂ | 155.86 |
| 13 | Ta₂O₅ | 110.39 |
| 14 | SiO₂ | 177.33 |
| 15 | Ta₂O₅ | 122.15 |
| 16 | SiO₂ | 188.25 |
| 17 | Ta₂O₅ | 126.66 |
| 18 | SiO₂ | 185.67 |
| 19 | Ta₂O₅ | 124.45 |
| 20 | SiO₂ | 188.06 |
| 21 | Ta₂O₅ | 127.8 |
| 22 | SiO₂ | 195.88 |
| 23 | Ta₂O₅ | 126.85 |
| 24 | SiO₂ | 187.68 |
| 25 | Ta₂O₅ | 124.77 |
| 26 | SiO₂ | 203.46 |
| 27 | Ta₂O₅ | 33.89 |
| 28 | SiO₂ | 19.56 |
| 29 | Ta₂O₅ | 100.29 |
| 30 | SiO₂ | 19.21 |
| 31 | Ta₂O₅ | 29.31 |
| 32 | SiO₂ | 196.4 |
| 33 | Ta₂O₅ | 126.51 |
| 34 | SiO₂ | 34.3 |
| 35 | Ta₂O₅ | 14.63 |
| 36 | SiO₂ | 214.75 |
| 37 | Ta₂O₅ | 15.73 |
| 38 | SiO₂ | 26.88 |
| 39 | Ta₂O₅ | 124.62 |
| 40 | SiO₂ | 29.66 |
| 41 | Ta₂O₅ | 16.28 |
| 42 | SiO₂ | 170.94 |
| 43 | Ta₂O₅ | 8.63 |
| 44 | SiO₂ | 35.91 |
| 45 | Ta₂O₅ | 124.27 |
| 46 | SiO₂ | 181.28 |
| 47 | Ta₂O₅ | 140.6 |
| 48 | SiO₂ | 40.46 |
| 49 | Ta₂O₅ | 22.11 |
| 50 | SiO₂ | 214.51 |
| 51 | Ta₂O₅ | 116.83 |
| 52 | SiO₂ | 14.42 |
| 53 | Ta₂O₅ | 11.41 |
| 54 | SiO₂ | 209.92 |
| 55 | Ta₂O₅ | 21.57 |
| 56 | SiO₂ | 35.72 |
| 57 | Ta₂O₅ | 137.34 |
| 58 | SiO₂ | 20.94 |
| 59 | Ta₂O₅ | 12.67 |
| 60 | SiO₂ | 200.33 |
| 61 | Ta₂O₅ | 19.7 |
| 62 | SiO₂ | 31.1 |
| 63 | Ta₂O₅ | 147.76 |
| 64 | SiO₂ | 28.05 |
| 65 | Ta₂O₅ | 14.9 |
| 66 | SiO₂ | 226.51 |
| 67 | Ta₂O₅ | 16.27 |
| 68 | SiO₂ | 32.08 |
| 69 | Ta₂O₅ | 133.98 |
| 70 | SiO₂ | 29.39 |
| 71 | Ta₂O₅ | 14.5 |
| 72 | SiO₂ | 272.44 |
| 73 | Ta₂O₅ | 10.77 |
| 74 | SiO₂ | 40.46 |
| 75 | Ta₂O₅ | 122.24 |
| 76 | SiO₂ | 192.37 |
| 77 | Ta₂O₅ | 30.67 |
| 78 | SiO₂ | 19.87 |
| 79 | Ta₂O₅ | 187.23 |
| 80 | SiO₂ | 29.81 |
| 81 | Ta₂O₅ | 21.08 |
| 82 | SiO₂ | 259.19 |
| 83 | Ta₂O₅ | 16.99 |
| 84 | SiO₂ | 35.91 |
| 85 | Ta₂O₅ | 169.86 |
| 86 | SiO₂ | 24.52 |
| 87 | Ta₂O₅ | 29.28 |
| 88 | SiO₂ | 216.15 |
| 89 | Ta₂O₅ | 28.79 |
| 90 | SiO₂ | 18.36 |
| 91 | Ta₂O₅ | 195.43 |
| 92 | SiO₂ | 23.95 |
| 93 | Ta₂O₅ | 21.62 |
| 94 | SiO₂ | 371.97 |
| 95 | Ta₂O₅ | 23.2 |
| 96 | SiO₂ | 22.7 |
| 97 | Ta₂O₅ | 196.3 |
| 98 | SiO₂ | 22 |
| 99 | Ta₂O₅ | 24.13 |
| 100 | SiO₂ | 211.96 |
| 101 | Ta₂O₅ | 25.64 |
| 102 | SiO₂ | 25.31 |
| 103 | Ta₂O₅ | 249.34 |
| 104 | SiO₂ | 26.52 |
| 105 | Ta₂O₅ | 21.38 |
| 106 | SiO₂ | 198.71 |
| 107 | Ta₂O₅ | 21.56 |
| 108 | SiO₂ | 25.27 |
| 109 | Ta₂O₅ | 220.75 |
| 110 | SiO₂ | 85.41 |

It should be noted that the coating represented by the plural layers provided in Table 2 is exemplary only and should not limit the scope of the claims appended herewith as multilayer IR reflecting coatings according to embodiments of the present subject matter may include any number of layers of tantala or silica having different thicknesses. Further, while coatings have been described as employing tantala and silica, additional coatings according to embodiments of the present subject matter may also include one or several layers of titanium dioxide, niobium pentoxide, tantala, hafnium dioxide, and/or silica to provide large optical, thermal and mechanical advantages in the construction of other exemplary coatings.

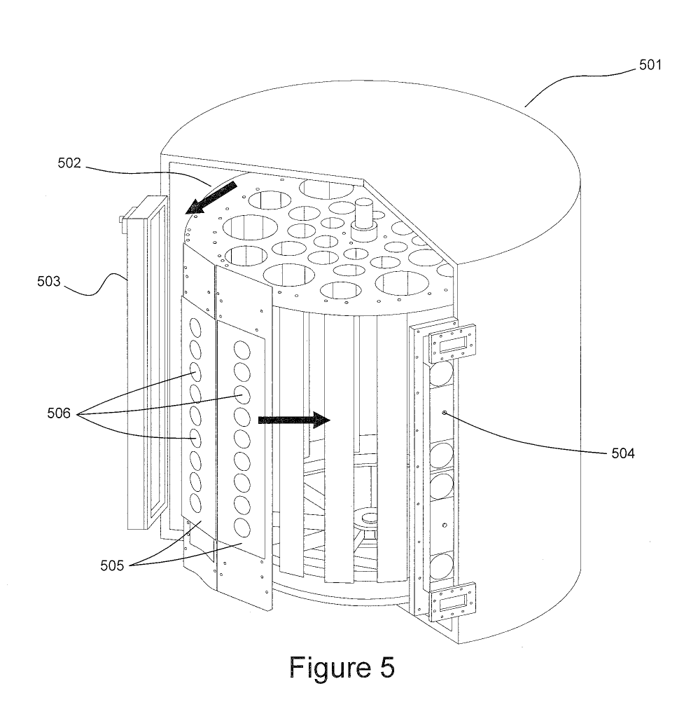

Multilayer coatings according to embodiments of the present subject matter may be manufactured or produced by any number of methods. For example, exemplary coatings may be sputtered utilizing a magnetron sputtering system. FIG. 5 is a perspective view of an exemplary magnetron sputtering system. With reference to FIG. 5, the magnetron sputtering system may utilize a cylindrical, rotatable drum 502 mounted in a vacuum chamber 501 having sputtering targets 503 located in a wall of the vacuum chamber 501. Plasma or microwave generators 504 known in the art may also be located in a wall of the vacuum chamber 501. Substrates 506 may be removably affixed to panels or substrate holders 505 on the drum 502.

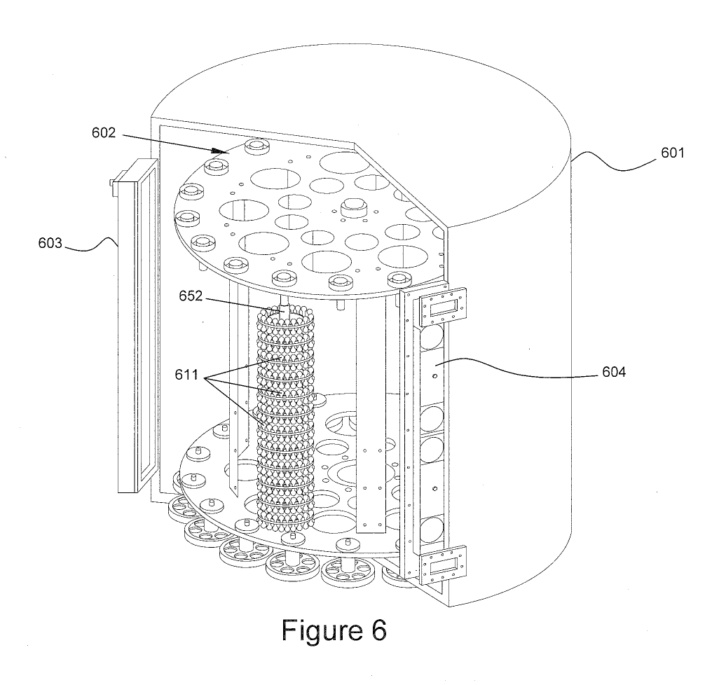

Embodiments of the present subject matter may also be manufactured in sputtering systems having tooling allowing more than one degree of rotational freedom. FIG. 6 is a perspective view of a such a sputtering system. With reference to FIG. 6, an exemplary sputtering system may utilize a substantially cylindrical, rotatable drum or carrier 602 mounted in a vacuum chamber 601 having sputtering targets 603 located in a wall of the vacuum chamber 601. Plasma or microwave generators 604 known in the art may also be located in a wall of the vacuum chamber 601. The carrier 602 may have a generally circular cross-section and is adaptable to rotate about a central axis. A driving mechanism (not shown) may be provided for rotating the carrier 602 about its central axis. A plurality of pallets 650 may be mounted on the carrier 602 in the vacuum chamber 670. Each pallet 650 may comprise a rotatable central shaft 652 and one or more disks 611 axially aligned along the central shaft 652. The disks 611 may provide a plurality of spindle carrying wells positioned about the periphery of the disk 611. Spindles may be carried in the wells, and each spindle may carry one or more substrates adaptable to rotate about it respective axis. Additional particulars and embodiments of this exemplary system are further described in co-pending and related U.S. patent application Ser. No. 12/155,544, filed Jun. 5, 2008, entitled, “Method and Apparatus for Low Cost High Rate Deposition Tooling,” and co-pending U.S. application Ser. No. 12/289,398, filed Oct. 27, 2008, entitled, “Thin Film Coating System and Method,” the entirety of each being incorporated herein by reference. Of course, embodiments of the present subject matter may also be manufactured using an in line coating mechanism or sputtering system and/or any conventional chemical vapor deposition system. Further, to obtain sufficient uniformity in coating may require plural rotations past the target or may require multiple targets.

One embodiment of the present subject matter may include a method of depositing films on a substrate. This may be accomplished utilizing the magnetron systems depicted in FIGS. 5 and 6, inline systems or other conventional sputtering systems. The method may include providing a vacuum chamber having one or more microwave generators therein and positioning a target of silicon or another substrate within the vacuum chamber. Power may then be applied to the target to thereby effect sputtering of a material from the target. Oxygen may be introduced into the vacuum chamber proximate to the microwave generator and power applied to the microwave generator thereby generating a plasma containing monatomic oxygen. The substrate may be moved past the target to effect the deposition of a material on the substrate and then moved past the microwave generator to effect the reaction of the material with oxygen to form, for example, tantala or silica, on the substrate. Of course, additional layers of materials may be sputter deposited upon the substrate or surface thereof.

In the aforementioned processing methods and systems, one exemplary method may be employed to improve the lumens per watt of a halogen incandescent burner comprising at least the steps of sputter coating a portion of the burner with a multilayer IR reflecting coating having alternating layers of tantala and silica with a total coating thickness of at least nine microns. The gain of such a coating may be at least 1.7, and the lumens per watt of the respective burner with the coating may also be at least forty over at least the first one thousand hours of operation of the burner. In another embodiment, the burner may operate with a luminous efficiency of less than forty-three LpW, e.g., 20 LpW, 30 LpW over less than one thousand hours of operation, e.g., five hundred hours of operation, seven hundred hours of operation, etc. Of course, the average reflectance of the coating over the range of wavelengths from 800 nm to 1500 nm may be at least 97. Another exemplary method may include providing a lamp burner having a quartz body forming a light emitting chamber housing an incandescent filament and sputter coating at least a portion of the light emitting chamber. The multilayer IR reflecting coating formed from this process may include a plurality of layers of tantala and silica and provide a total coating thickness of at least nine microns where the gain realized by coating the burner may be at least 1.7. In another embodiment, the sputter coating may include forming alternating layers of tantala and silica. It should be noted that each of the aforementioned embodiments identifying specific efficiencies, gains, reflectance values, etc. are exemplary only and should in no way limit the scope of the claims appended herewith.

As shown by the various configurations and embodiments illustrated in FIGS. 1-6, the various embodiments of high gain coatings and methods have been described.

While preferred embodiments of the present subject matter have been described, it is to be understood that the embodiments described are illustrative only and that the scope of the invention is to be defined solely by the appended claims when accorded a full range of equivalence, many variations and modifications naturally occurring to those of skill in the art from a perusal hereof

What we claim is:

1. A halogen incandescent burner comprising:
a quartz body comprising a light emitting chamber;
a filament positioned within said light emitting chamber; and
a multilayer optical coating on at least a portion of said chamber, said coating comprising a plurality of layers of a low refractive index material and a high refractive index material having a total thickness of at least nine microns,
wherein the gain of said burner is at least 1.7.

2. The burner of claim 1 wherein said high refractive index material comprises tantala.

3. The burner of claim 1 wherein said low refractive index material comprises silica.

4. The burner of claim 1 wherein said coating comprises alternating layers of tantala and silica.

5. The burner of claim 4 wherein said burner operates with a luminous efficiency of at least forty lumens per watt over at least one thousand hours of operation.

6. The burner of claim 1 wherein said burner operates with a luminous efficiency of at least thirty lumens per watt over at least five-hundred hours of operation.

7. The burner of claim 6 wherein said burner operates with a luminous efficiency of at least thirty lumens per watt over at least one thousand hours of operation.

8. The burner of claim 6 wherein said burner is rated at sixty watts and operates with a luminous efficiency of about forty-three lumens per watt over at least one thousand hours of operation.

9. The burner of claim 1 having an average reflectance over the range of wavelengths from 800 nm to 1500 nm of at least 97.

10. The burner of claim 1 used as a light source in a type of lamp selected from the group consisting of an A-line lamp, a general service lamp, a modified spectrum lamp, a reflector lamp, a parabolic reflector lamp, an ER/BR lamp, and a torchiere.

11. The burner of claim 1 wherein said coating comprises alternating layers of tantala and silica having a total thickness of at least eleven microns and wherein the gain of said burner is at least 1.85.

12. The burner of claim 1 forming a double-ended burner.

13. The burner of claim 1 forming a single-ended burner.

14. The burner of claim 1 wherein said coating comprises alternating layers of tantala and silica having a total thickness of at least eleven microns.

15. A halogen incandescent burner having an infrared reflecting coating on at least a portion thereof, said coating comprising alternating layers of tantala and silica and having a total thickness of greater than nine microns and a gain of at least 1.7.

16. The burner of claim 15 wherein said coating comprises alternating layers of tantala and silica and has a total thickness of at least eleven microns and a gain of at least 1.85.

17. A halogen incandescent burner having an infrared reflecting coating on at least a portion thereof, said coating comprising alternating layers of tantala and silica and having a total thickness of greater than nine microns and an average reflectance over the range of wavelengths from 800 nm to 1500 nm of at least 97.

18. The burner of claim 17 wherein said coating comprises alternating layers of tantala and silica and has a total thickness of at least eleven microns.

19. A halogen incandescent burner having an infrared reflecting coating on at least a portion thereof, said coating comprising alternating layers of tantala and silica and having a total thickness of greater than nine microns and a luminous efficiency of at least thirty lumens per watt over at least five hundred hours of operation.

20. The burner of claim 19 wherein said burner operates with a luminous efficiency of at least thirty lumens per watt over at least one thousand hours of operation.

21. The burner of claim 20 wherein said burner operates with a luminous efficiency of about forty-three lumens per watt over at least one thousand hours of operation.

22. The burner of claim 19 wherein said coating comprises alternating layers of tantala and silica and has a total thickness of at least eleven microns.

23. A method of improving the lumens per watt of a halogen incandescent burner comprising sputter coating at least a portion of the burner with a multilayer infrared reflecting coating having alternating layers of tantala and silica a total thickness of at least nine microns.

24. The method of claim 23 wherein the gain is at least 1.7.

25. The method of claim 23 wherein the lumens per watt of the burner with the coating is at least thirty over at least the first five hundred hours of operation of the burner.

26. method of claim 25 wherein the lumens per watt of the burner with the coating is at least forty over at least the first one thousand hours of operation of the burner.

27. The method of claim 23 wherein the average reflectance of the coating over the range of wavelengths from 800 nm to 1500 nm is at least 97.

28. A method comprising:
providing a lamp burner having a quartz body forming a light emitting chamber housing an incandescent filament;
sputter coating at least a portion of the light emitting chamber to thereby form a multilayer infrared reflecting coating having a plurality of layers of tantala and silica and a total thickness of at least nine microns,
wherein the gain realized by coating the burner is at least 1.7.

29. The method of claim 28 wherein said sputter coating includes forming alternating layers of tantala and silica.
